(19) United States
(12) Patent Application Publication
(10) Pub. No.: US 2014/0129493 A1
(43) Pub. Date: May 8, 2014

(54) Method and System for Visualizing Complex Data via a Multi-Agent Query Engine

(71) Applicant: Orboros, Inc., Toronto (CA)

(72) Inventor: Henry Leopold, Toronto (CA)

(73) Assignee: Orboros, Inc., Toronto (CA)

(21) Appl. No.: 14/052,688

(22) Filed: Oct. 11, 2013

Related U.S. Application Data
(60) Provisional application No. 61/712,269, filed on Oct. 11, 2012.

(51) Int. Cl. G06F 19/00; G06N 5/02; G06F 17/30

(52) U.S. Cl. CPC G06F 19/32; G06F 17/30572; G06N 5/025
USPC 706/12; 707/603

(57) ABSTRACT

An interactive and intelligent user interface for inputting a query, generating a query result including one or more matching concepts stored in a knowledgebase of one or more media types, and presenting the user with a rich personalized query result based on the user's preferences and personal information, and provides improved relevant search results.

### CROSS-REFERENCE TO RELATED APPLICATIONS

This application claims the benefit of priority to U.S. Provisional Application Ser. No. 61/712,269, filed on Oct. 11, 2012.

### FIELD OF THE INVENTION

The present invention relates to a method and system for personalized management of medical conditions, body function, health, and wellness.

### DESCRIPTION OF THE RELATED ART

The World Wide Web provides new opportunities for people to share information, opinions, and experiences on virtually any topic. Web-based systems and methodologies enable the communication and near-instant transmission of ideas globally, while search engines allow the rapid retrieval of information about nearly any subject matter. A search engine is a computer program that generates a number of results from one or more databases of information following a query by a user. Search result relevance is a key metric in determining a search engine's performance, leading to the ranking of results based on multiple criteria that varies from one engine to the next. Typically, click through rates and number of links to other web pages are used to assess website result quality.

Health-related sites and applications (apps) which provide information to user have been rising in popularity. Some of these sites provide information, supportive communities, and in-depth reference material from content providers about health subjects that matter to users. However, while these resources intend to educate users, they usually inundate the user with information, leaving the user to sift through the copious amounts of data. In order to overcome this drawback, some web sites are tailored to serve a particular demographic that shares common goals, concerns or attributes. However, none of these approaches effectively address the need for citizen-centric model of care, concerned with the integration, virtualization and management of information in distributed environments that support cross domain collections of users and resources to improve the quality of care and effectiveness of research, tests and treatments.

It is an object of the present invention to mitigate or obviate at least one of the above-mentioned disadvantages.

### SUMMARY OF THE INVENTION

In one of its aspects, there is provided a computer-implemented method for heterogeneous data management and/or for managing data relevance and generating data/metadata relevance representation, the method comprising the steps of:

obtaining, via a network environment, information from a at least one data source;

modeling, by a data/metadata modeling unit, the data/metadata from each of the data sources based on at least one feature and/or granularity information and/or data/metadata model(s) associated with the data/metadata to generate data/metadata models;

integrating, by a data/metadata integration unit, the data/metadata from at least one data source, by applying at least one process to the data/metadata from different data sources in accordance with the data/metadata models, to generate integrated data/metadata;

creating, by a relevance representation generator, a relevance representation of the integrated data/metadata that traces sources, granularities, and/or processes applied to generate the integrated data/metadata;

receiving, by a data/metadata manager, a query originated from a user, regarding information associated with the integrated data/metadata;

providing, by the data/metadata manager, a response directed to the query derived based on the relevance representation of the integrated data/metadata;

generating, by a page generator, instructions corresponding to the creation of a dashboard/visualization/interface to display a query result based on the relevance representation of the integrated data/metadata;

updating, by a data/metadata manager, a response directed to the relevance representation generator and/or page generator, based on a query, data/metadata and model relevance and/or granularity, model and/or instructions and/or response that may have originated from a user and/or a model and/or a data/metadata manager; and

archiving the relevance representation of the integrated data/metadata for enabling an query associated with the integrated data/metadata on source and/or granularity.

In yet another of its aspects, there is provided a system for heterogeneous data management and/or for managing data relevance and generating data/metadata relevance representation, the system comprising:

a heterogeneous data/metadata input unit configured for obtaining, via a network environment, information from a plurality of data sources;

a data/metadata modeling unit configured for modeling the data/metadata from each of the data sources based on a source and/or granularity information associated with the data/metadata to generate at least one data/metadata model;

a data/metadata integration unit configured for integrating the data/metadata from at least one data source, by applying at least one process to the data/metadata from different data sources in accordance with at least one data/metadata model, to generate integrated data/metadata;

a relevance representation generator configured for creating a relevance representation of the integrated data/metadata that traces sources, granularities, user preferences, user histories and/or processes applied to generate the integrated data/metadata;

a data/metadata manager configured for receiving a query, originated from a user, regarding information associated with the integrated data/metadata and providing a response directed to the query based on the relevance representation of the integrated data/metadata.

In yet another of its aspects, there is provided a method for providing automatic decision support with heterogeneous data/metadata, data/metadata models and/or machine intelligence(s), comprising of:

in response to receiving a query or request pertaining to a plurality of determinants deploying portals utilizing a data, statistical or algorithmic model to predict a plurality of scientific, medical, social or economic processes, outcomes or methods, such as, but not limited to market access, economic valuation or scientific valuation;

assessment of at least one model generated for each model of each outcome to select an optimal outcome and/or template to be presented;

assessment of a plurality of competing models generated for each model of each outcome to select an optimal outcome and/or template to be presented; and selection of at least one model generated for each model and/or data/metadata.

In yet another of its aspects, there is provided a method for heterogeneous data management by cooperative systems where machine intelligent agents interact with a user via an interface to enhance system functionality and user experience, quality and efficiency of design, wherein:

in response to receiving a query or request pertaining to at least one query, determinant, data/metadata, model and/or outcome, deploying portals utilizing at least one data/metadata model;

assessment of at least one model generated for each model of each outcome to select an optimal outcome and/or template to be presented;

users' behavior models are generated to incentivize user engagement and/or activity by rewarding users for at least one of communicating with other users, competing with other users, participating in multi-user activities, and wherein users' behavior models are used to enhance cooperation and collaboration within a social network environment.

In yet another of its aspects, there is provided a processing system and a method for personalized management of medical condition, body function, health, and wellness. The method and system is relates to the entering of personalized data and query parameters for searching an indexed and potentially distributed and/or federated database, and producing a query result particular to the person; and the method and system is further directed toward the viewing and analysis of personal metrics and attributes to better understand and manage one's health, and wellness; and aggregation, retrieval and ad hoc visualization of a plethora of information of multiple data types and specificity.

In yet another of its aspects, there is provided a method for the creation of personal information pages populated with information aggregated from multiple sources, where such information is analyzed, presenting patterns, trends and habits, providing the user insight into their own health and wellness. The method further relates to presenting users with materials to empower users with the knowledge to better understand and manage their health and wellness, and to presenting users with a means to manage and forecast their health based on quantitative data augmented by machine intelligences. Additionally, this method uses cooperative systems where machine intelligent agents interact with a user via an interface to enhance system functionality and user experience, in addition to overall quality and efficiency of design.

In yet another of its aspects, there is provided social network environments where users are able to share personal information pages and communicating with other members of the social network to better enhance their health and wellness through communication and understanding, thus enhancing cooperation and collaboration within a social network environment.

Advantageously, there is provided an interactive and intelligent user interface for inputting a query, generating a query result including one or more matching concepts stored in a knowledgebase of one or more media types, and presenting the user with a rich personalized query result based on the user's preferences and personal information, and provides improved relevant search results. The search results include sponsored links and algorithmic search results, are generated in response to a query, and are ranked first based upon query relevancy and then later adjusted based on user preference and search history.

### BRIEF DESCRIPTION OF THE DRAWINGS

Several exemplary embodiments of the present invention will now be described, by way of example only, with reference to the appended drawings in which:

FIG. 1 is a top-level component architecture diagram of an exemplary system;

FIG. 2 shows a flow diagram illustrating an information retrieval process using a search engine;

FIG. 3 is a flow diagram showing exemplary method steps for generating personalized query results using an adaptive query engine;

FIG. 4 is a flow diagram showing exemplary method steps for authenticating a user by a third party application;

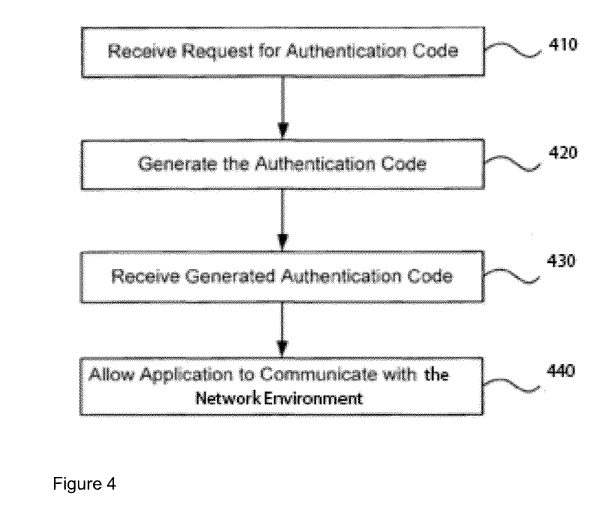

FIG. 5 is a flow diagram showing exemplary method steps for accessing a a third party database during a query;

FIG. 6 shows an exemplary framework for a query result page;

FIG. 7 is a flow diagram showing exemplary method steps for updating dissatisfactory query results by a user;

FIG. 8 is a flow diagram showing exemplary method steps page generation;

FIG. 9 shows an exemplary framework for a user whiteboard, personal dashboard or knowledge hub page; and

FIG. 10 shows an exemplary user home page or profile page.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

As used in the specification and claims, the singular form “a,” “an,” and “the” include plural references unless the context clearly dictates otherwise.

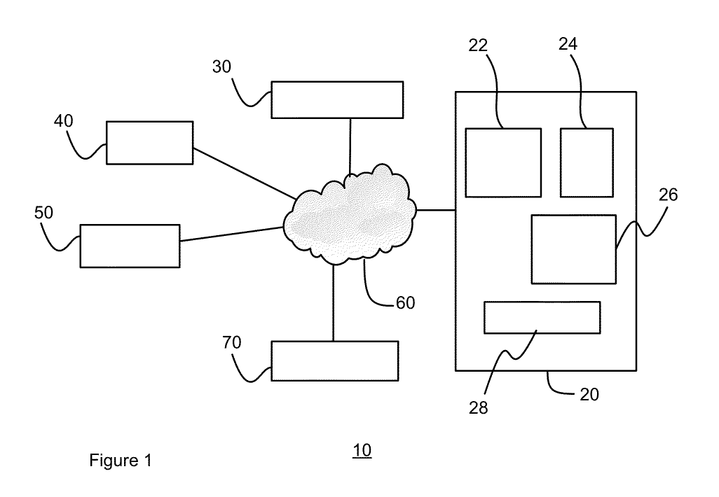

Particular embodiments may operate in, or in conjunction with, a wide area network environment, such as the Internet, including multiple network addressable systems. FIG. 1 shows a top-level component architecture diagram of an exemplary system, generally identified by reference numeral 10, for performing the various methods described below. The system 10 generally includes communication network 60 generally represents one or more interconnected networks, over which various systems and hosts described herein may communicate, network environment 20 and client devices 30, one or more third party web application servers (“web application server”) 40 and one or more enterprise servers 50. Client devices 30, web application servers 40, and enterprise servers 50 may be operably connected to the network environment and communication network 60 via a network service provider, a wireless carrier, a set of routers or networking switches, or any other suitable means, and mobile sensors 70. Each client device 30, web application server 40, or enterprise server 50 may generally be a computer, computing system, or computing device including functionality for communicating (e.g., remotely) over a computer network. Communication network 60 may include packet-based wide area networks (such as the Internet), private networks, wireless networks, satellite networks, cellular networks, paging networks, and the like.

Network environment 20 may contain various components comprising of, but not limited to an application program interface (or “API”), a network, a third-party application, a scripting language, optional business logic rules, a volatile cache memory, a distributed database, a network device with an Internet browser, a network device without an Internet browser, server(s) 22, knowledgebase(s) 24, management system(s) 26 and search engine(s) 28. Particular embodiments further relate to a method for populating a “knowledgebase” 24 using data obtained from one or more internal or external sources. In particular embodiments, the knowledgebase 24 includes an index of known concepts as well as, in some embodiments, various attributes, metadata, or other information associated with the respective concepts, such as edges. In particular embodiments, one or more backend (server-side) processes crawl one or more external data sources (e.g., WIKIPEDIA (http://www.wikipedia.org), FREEBASE (http://www.freebase.com, available from METAWEB), or the Internet in general) to facilitate or aid in generating or populating the knowledgebase 24. In some embodiments, the knowledgebase 24 may also be augmented with information extracted from users of the network environment described herein. The management system 26 is also responsible for accessing enterprise servers 50, web application servers 40, client devices 30 and mobile sensors 70. Over such instances, the network environment 20 may access 3^{rd} party databases, which may or may not be distributed. In particular embodiments, this invention incorporates frontend and backend type-ahead processes, in addition to auto fill and other agent-based systems not aforementioned or mentioned explicitly.

In particular embodiments, network environment 20 maintain query database that may be indexed and stored within one or more servers 22 as a component of the knowledgebase 24 or within a separate database. The query database may identify information such as, but not limited to, information identifying the user who submitted the query, query submission time or the geographic location of the client device used to submit the query. This data may be analyzed by an agent and further refined. In particular embodiments, the query database can be crawled by the knowledgebase, adding the information to the collective store. The network environment 20 may be configured to provide the degree of separation between two individuals.

The server may be in communication with the knowledgebase, which may be operated through a database management system 26. The management system 26 may impose logic and rules upon the data to form a structured organization through the use of software agents, machine intelligence, predefined rules, etc.

In one exemplary embodiment, a knowledgebase 24 may include data associated with any type of data including user attributes, social, environmental, medical, disease, different network environment 20, client devices 30, web application servers 40, or enterprise servers 50, etc. Particular embodiments relate to a network environment 20 that includes a platform enabling an integrated network environment. Such an environment may include one or more searchable or query-able indexes of nodes or edges generated by indexing the knowledgebase 24. In alternate embodiments, the knowledgebase 24 is not indexed. Edges can be formed between any aforementioned nodes. For example, the knowledgebase can include one or more correlations between attribute data and at least another data type, such as location, quality of life, clinical trial information or dietary habits.

User attributes may include one or more nodes of demographic information, consisting of but not limited to: age, race, ethnicity, gender, height, weight, body mass index (BMI), body volume index (BVI), genotype, phenotype, disease, disease severity, disease progression rate, measures of functional ability, quality of life, interventions, mood, remedies and other biometric or physiological data pertaining to the user. Attributes may also include one or more diseases currently or previously affecting the user, one or more interventions a user has or is utilizing in addition to one or more side effects experienced by the user. Those skilled in the art will appreciate that these lists are far from comprehensive and serve to provide an ideation of what an attribute encompasses.

A user community refers to the users of a particular social network. A user community may include users with restricted access to the web-based system that have provided one or more personalized attribute entries stored within the network environment. Users are able to assess, track, and manage their attributes by accessing the social network via a client device. A user is better able to understand their health by sharing their experience and progress with others within the user community. Users are able to communicate with like-minded individuals, and by provide support to one another, which allows for superior management of ones health and wellness for the prevention of disease. Visualization assist users in understanding information pertaining to their health, and by viewing their attributes and attribute relationships, are better able to elucidate how choices and habits effect their health in many ways. In particular embodiments, a user community can be integrated with other online communities. For example, an online review community can be integrated with a social network services such as FACEBOOK®, available from Facebook, Inc. of Palo Alto, Calif., U.S.A.; GATHER.COM®, available from Gather Inc. of Boston, Mass., U.S.A.; LINKEDIN®, available from LinkedIn Corp. of Mountain View, Calif., U.S.A; PATIENTSLIKEME®, available from PatientsLikeMe, Inc. of Cambridge, Mass., U.S.A.; and the like.

In particular embodiments, the first sets of administered nodes are user-administered nodes (hereinafter also referred to as “user nodes”) that each corresponds to a respective user and a respective user profile page of that user. In one exemplary embodiment, search histories and user information are stored via user nodes. In particular embodiments, user profile pages corresponding to user nodes may be modified, written to, or otherwise administered by, and only by, their respective owner (registered) users (unless an official network administrator desires or requires access to modify or delete a user's profile page, e.g., as a result of unscrupulous or otherwise inappropriate action on the part of the registered user). In particular embodiments, the first set of user nodes includes a first subset of authenticated nodes and a second set of un-authenticated nodes. In a particular embodiment, the first subset of authenticated nodes correspond to respective registered authenticated users while the second subset of un-authenticated nodes correspond to registered users who have not been authenticated.

For example, an authenticated user may be a user who has been verified to be who they claim to be in his or her respective profile page while an un-authenticated user may be a user who has not been verified to be who they claim to be in his or her respective profile page (e.g., a user who claims to be an expert in a field of specialization). In some embodiments, for some existing user profile pages, network environment 20 may determine whether the administrator of the user profile page is truly the authentic voice of the claimed user (i.e. the real person the user claims to be) or having the claimed expertise. If it is determined that the current administrator is not the authentic or true claimed user, the network environment 20 may remove the user's administrative rights to the page, freeze the user account and/or block future use of the environment to that user. In this way, the user node and corresponding user profile page may be redefined in the database information stored in knowledge base 24 or database as a concept node and corresponding concept profile page

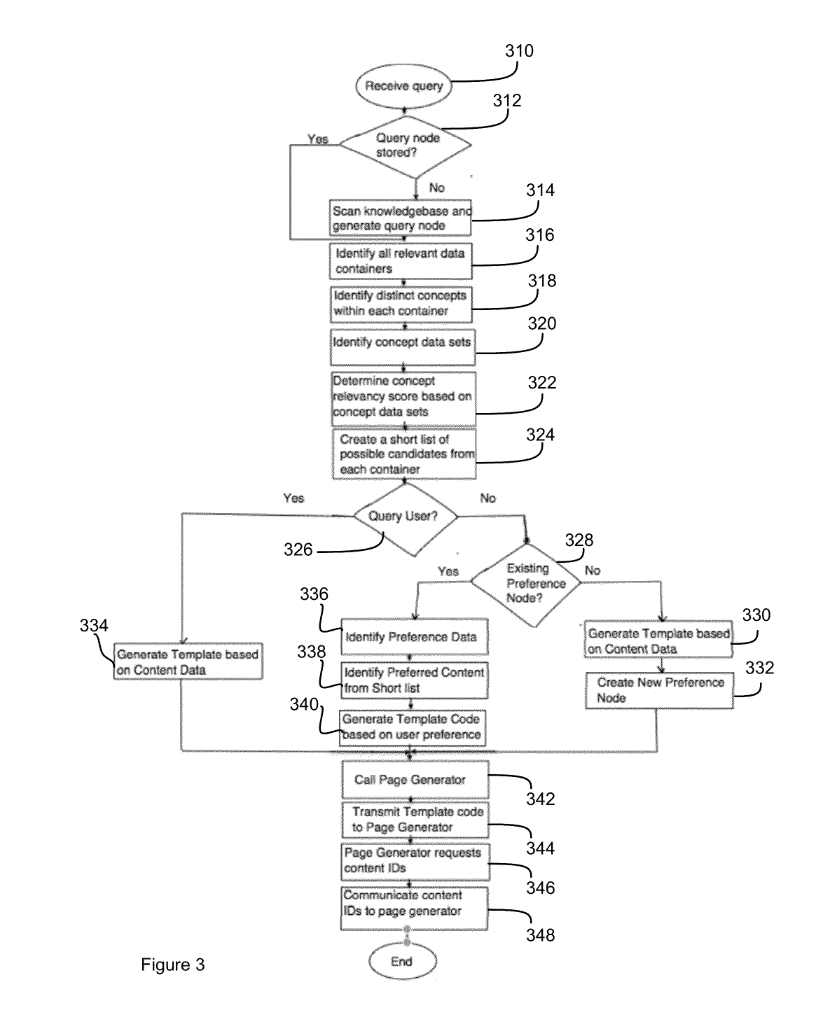

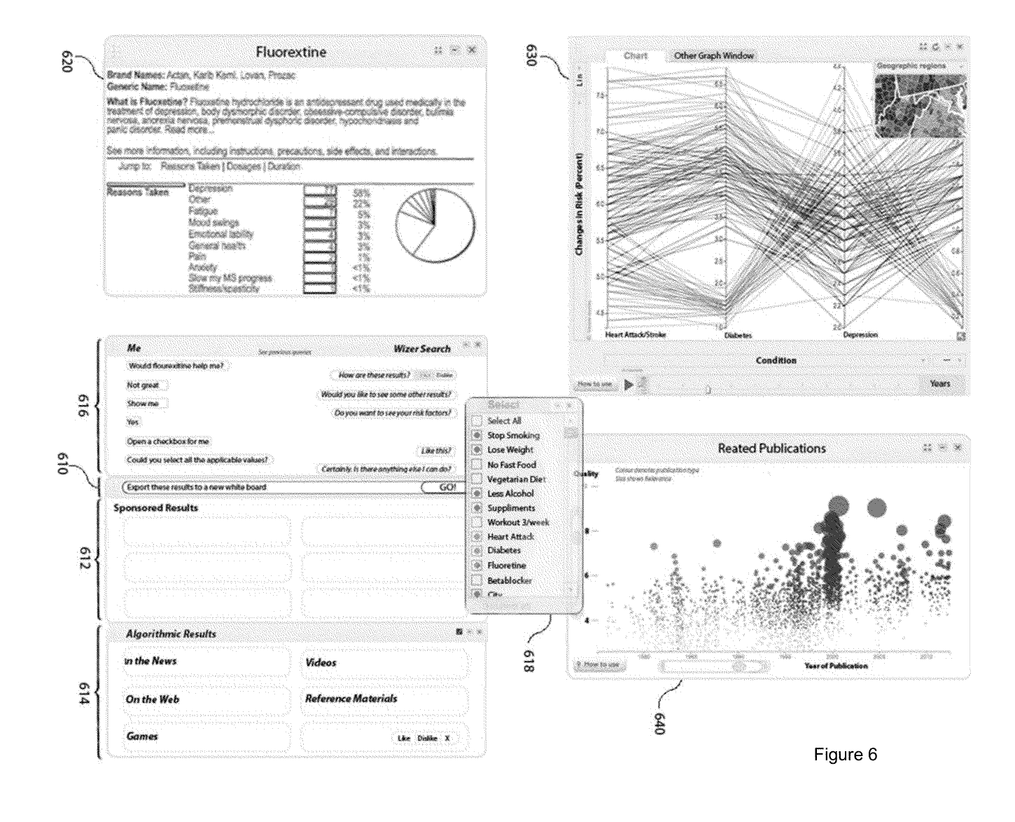

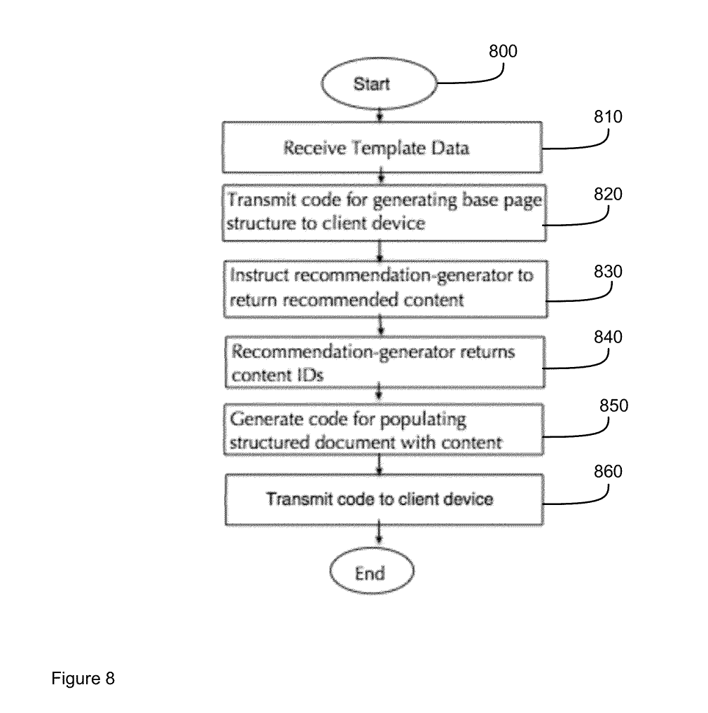

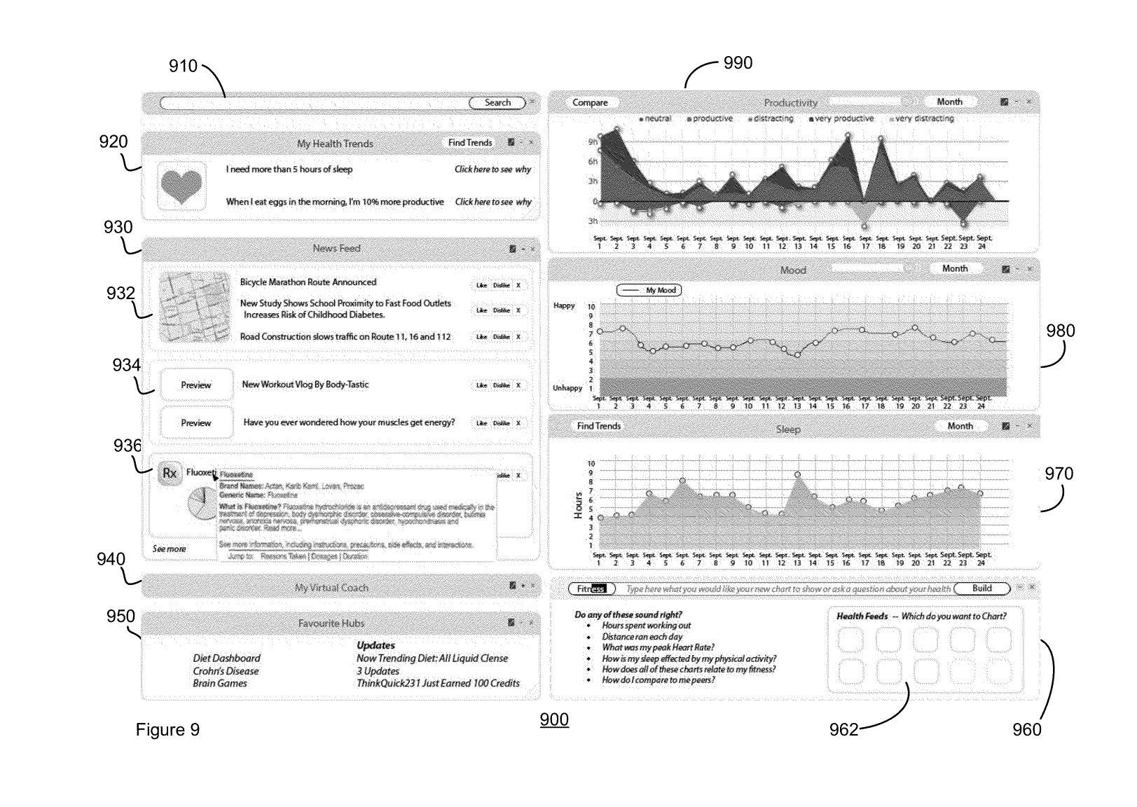

In exemplary embodiments, unregistered users are able to use some features of the network environment (hereinafter also referred to as “query users”). Query users do not have active user or concept nodes. In particular embodiments, the network environment 20 may request, but not require a query user to authenticate his or her identity. In particular embodiments, when a query user of network environment 20 first requests a web page from network environment 20 in a given user session, the response transmitted to the user's client device 30 from network environment 20 may include a structured document generated by page-generating process “page generator”, as described below in more detail, with reference to FIG. 3, step 342 and FIG. 8. The user may then enter his or her user login credentials (e.g., user identifier and password), which are then transmitted from the user's client device 30 to network environment 20. Upon successful authentication of the user, network environment 20 may then transmit a response to the client device 30 that includes a structured document generated the page generator for rendering a query result, as shown in FIG. 6, or user page at the client device 30, as shown in FIG. 9.

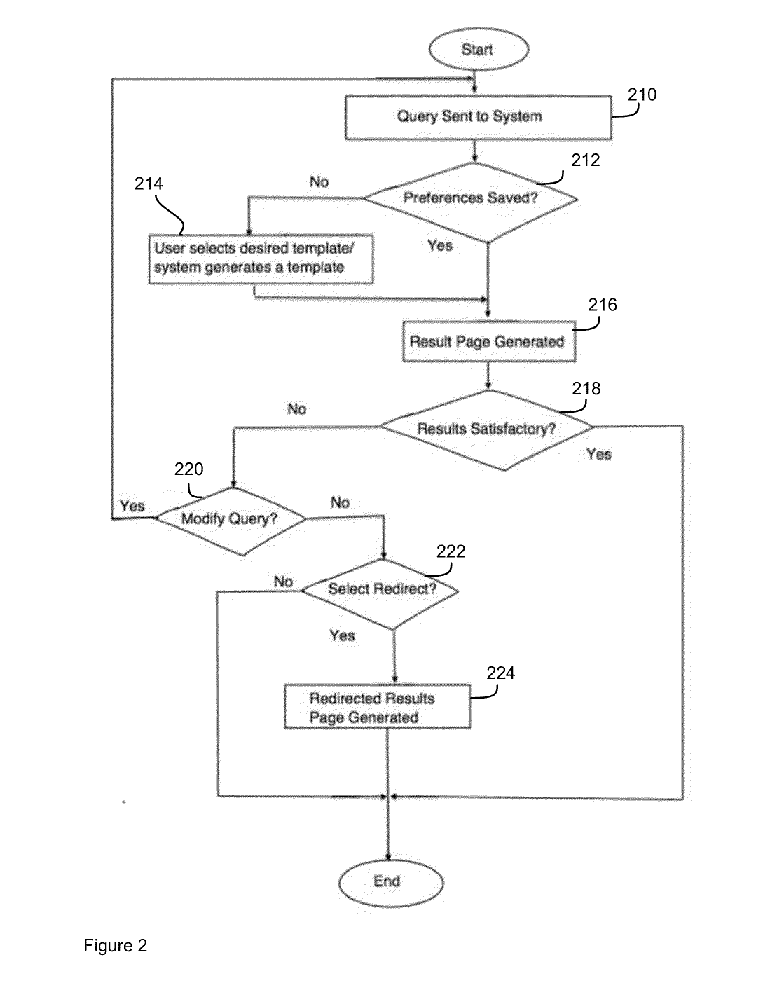

FIG. 2 shows a flow diagram illustrating an information retrieval process using a search engine 28. The user first transmits a query into the system (step 210). Depending on whether the user has pre-existing search preferences (step 212), one of two actions transpires next. In particular embodiments, if the user is a query user or does not have existing preferences, the system prompts them to select an template for the search results (step 214); the template examples may be populated with results or not. In other embodiments the system automatically selects a template. Once a template has been selected, a page is generated (step 216), following the page generation process as shown in FIGS. 6 and 8, and the user determines whether the results are satisfactory (step 218). If the results are satisfactory, the process ends, otherwise the user is presented with the option to modify the query (step 220). The user may choose redefine the query with additional criteria or pose a new query. If the user chooses to modify the query (step 220), this process begins again at step 210, else the user determines whether to select a redirect to another page (step 222). If the user selects to be redirected (step 224), the new result page is generated, else the process ends.

In particular embodiments of the invention, the operator of the online social network may act as an application service provider (ASP) that maintains the third party database, on behalf of the third party. In such a case, the network environment periodically calls the social network information maintained on the distributed servers, from the third party database, or provides an information map, so that the social network information will be made available for use without information transference.

The terms: users, registered users, query users, nodes, frontend type-ahead processes, backend type-ahead processes, auto fill, hovering, concepts, profile pages, hubs (topic profile pages), fans, likes, interests, connections, query database, indexing, friends and other terms typically used in regards to social networks and web based applications are well known in the art, and will not be described further herein.

According to various exemplary systems and methods, the web application server 40 operates third-party applications that may be a program that utilizes information found in one or more distributed databases. The third-party application may be an application created by and/or offered by a party or entity that is unknown and therefore not trusted nor checked for problems by an administrator of the distributed database environment and/or an administrator of a web-based network. For instance, a distributed database for a social network may include profiles, photos, friends and/or relevant events for each user or member of the social network. The third-party application may be a program such as a program that collects information on user mood or productivity and visualizes the information in the form of a temporal graph. Accordingly, the third-party application may share user information and/or photo(s) for a particular user between different networks. The third-party application may reside on a server internal or external to a web-based social network. The third-party application may also be a desktop software application, a widget, and a software application on a client device 30. In particular embodiments, the third-party application may be a software tool that resides on or works on a mobile sensor 70 or client device 30 such as a game console, digital camera, cell phone, or biometric sensor (all of which may lack an Internet browser) with a connection to a network that may communicate data with a communication network 60.

In one further exemplary system and method, the optional business logic rules may represent limitations such as privacy settings that may be applied to data communicated with the third-party application. Such limitations may be selected by an owner of the data and/or by a network administrator. For example, a user may limit the other members of the network or with the third-party application unless the member may continue to impose certain limitations upon the personal information and the way it is used by the third-party application. The scripting language, according to various exemplary systems and methods, may be any programming environment typically used to create dynamic web pages. The environment may extract data out of the volatile cache memory and apply the business logic rules against extracted data. It is this data (with or without application of the business logic rules) that is generally provided to or by the web application server 40 via an API.

In one exemplary system and method, the web application server 40 may access some or all of the information found in the distributed databases. For example, the third-party application, such as the third-party application for the generation of temporal figures, may access a distributed database associated with a social network through an application program interface for the social network. The retrieved information could be shared between to the environment 60, enterprise servers 50 or other external distributed servers/data sources. Third party applications 40 may use authentication IDs and user information to control the visibility of information in the third party database. For example, the third party application might store productivity scores, or other personal information in a third party database, and require user permissions to release the information within the database. Using the information obtained from the network environment 20, the third party application may limit access to user information stored in the web application database. Particular embodiments may incorporate security features including but not limited to: MD5 and SHA-1, Message Authentication Code (MAC) used as the hash algorithm; MAC is a one-way hash algorithm but uses a secret key that the party maintaining social network information and the party requesting information through an API would agree to in advance, thus the use of a key provides extra security.

Network environment 20 further includes a real time search engine 28. FIG. 3 is a flow diagram showing exemplary method steps for generating personalized query results using an adaptive query engine. The method allows for the collection, storage and analysis of a user's query history, stored within a “preference node” and “query node”, described below. The query engine is able to measure user preference from how the user responded to previous query results, thus allowing the method to generate tailored query results in response to a query entered by user. At step 310, the method begins by receiving a query from a search engine interface to aggregate one or more sources of information from within the knowledgebase 24, enterprise servers 50, web application servers 40 or other accessible information/databases. In response to the query (step 312), the method determines if a query node required for the query is stored in memory. A query node retains histories of similar searches and the result indexes previously generated. If so, the method continues to step 316. If not, the method searches the knowledgebase for related documents in an index, or search-engine index, and generates a novel query node (step 314). In step 316, the indexes are used to identify and return a first result set containing document IDs (“container”) from a primary query parsed from the query node. Concurrently, the same process identifies a second container. In step 318, the contents of the containers are compared and evaluated and relevant concepts are identified. At step 320, the content is organized into data sets that are then attributed with content relevancy scores in step 322. At step 324, a short list of document IDs is collected from at least subsets of the identified document IDs that have similar relevancy to the first and secondary result sets.

In the next step, a check is made to determine whether the user is a query user (step 326). If so, the shortlist is used to generate code for a template populated with applicable, step 334, and the process moves on to step 342. If the user is not a query user, then the system checks if the user node contains any preferences (“preference node”) potentially including other user attributes such as (but not limited to) demographics, medical history, search history, social network data, etc., (step 328). If not, the system generates code for a template based on the shortlist of content data (step 330); and creates a new preference attached to the user node (step 332) and moves on to step 342. If the user does have an existing preference node, then the method moves on to step 336. In step 336, the method analyzes the user's preferences and determines if the user prefers specific types of results, such as (but not limited to) videos, news articles or publications, and any other features that may be considered a preference. In step 338, the relevancy scores of the data within the shortlist are re-evaluated based upon the user preferences, new data matching the updated relevancy scores is aggregated, ranked and a new shortlist created. Next, a template code is generated using the updated shortlist (step 340). In step 342, a page-generation process (“page generator”) is invoked, as described in detail below with reference to FIG. 8. The method then transmits the template code to the page generator, step 344, which after receiving the code in step 810, requests the content IDs in step 830. In step 346, this method receives the request for one or more IDs and transmits them as necessary.

In particular embodiments, recommendation-generating process (step 322) scores the concept relevancy in each of the first and second data sets and then combines the resulting scores. In such an implementation, recommendation-generating process may then generate a combined data set that includes all of the contents in each of the first and second data sets and combine or correlate the scoring results based on each of the first and second data sets to generate a single correlated score for each of the contents in the combined data set. The single correlated scores for the potential results are then used in ranking the concepts in the correlated short list (step 324). In one implementation, the weights assigned to the concepts in the first and second data sets are themselves weighted equally by recommendation-generating process (step 322). By way of example, a data set with a weight of five from the first data set may be assigned a score of five in the single correlated ranked list. Similarly, a data set with a weight of four from the second data set may be assigned a score of four in the single correlated ranked list. Additionally, as the first and second data sets may share common concepts, if a concept returned in both of the first and second data sets was assigned a weight of six based on the first data set and assigned a weight of three based on the second data set, recommendation-generating process may sum the individual weights and assign the data set a score of nine in the single correlated ranked list (6+3=9). In alternative embodiments, recommendation-generating process (step 322) may use three or more containers to balance the initial weighting of concepts.

In alternative embodiments, the template code contains the document/content IDs. In alternate embodiments, the page generator receives the content IDs and does not need to request them. In yet another alternative embodiment, the query user check (step 326) and user preference check (step 328) are separate processes. In yet another alternative embodiment, the query user check (step 326) and or the user preference check (step 328), are not part of the query method described with reference to FIG. 3 and are instead called by the management system 26, when needed. Although the method described with reference to FIG. 3 is shown to transpire in a particular sequence, other sequences are possible, as well, in other embodiments. In particular embodiments, recommendation-generating process (step 322) may first combine the first and second data sets to generate one combined data set and then score each of the concepts in the resultant combined data set. In this way, concepts shared between the data sets may be accounted for, if desired, before generating a score for the hub. The identification of concepts may be based on any suitable algorithm or algorithms.

In particular embodiments, as described above, knowledgebase 24 may include one or more query-able indexes generated by indexing the data with the knowledgebase 24. In particular embodiments, the indexes may be stored in one or more data stores or databases outside of the knowledgebase 24. In particular embodiments, indexes are generated, updated, transferred, exchanged and maintained periodically. In particular embodiments, the query engine can also create and leverage user profiles and patterns of similar users to further tailor queries. In particular embodiments, the user can rank the appropriateness or usefulness of each piece of returned information, which can be used to further tailor query results.

When network environment 20 receives a query submitted by a user, query indexing module (step 312) parses and stores the query as described above. In particular embodiments, a topic analyzer extracts one or more topics from the query. The extraction of topics from the query may involve one or more of a number of known topic identification technologies. For example, contemporaneous to step 312, a topic analyzer may be utilized to extract one or more topics from one or more terms identified by query indexing module (step 312). In alternate embodiments, the topic analyzer may occur at any of the steps including, but not limited to steps 312, 314, 316, 318, 320, 322 and 324. Topic analyzer may then associate a topic identifier to the topic and store the topic identifier in topic database along with identifying information and metadata including the query, or query identifier, associated with the query the topic was extracted from. Additionally or alternately, each query node may have a topic identifier stored with it. Additionally or alternatively, the topics identifiers may be stored within or rather, be a component of the query node. In particular embodiments, queries may include any kind of media and such, topics analyzer may be configured to identify the one or more topics from a query that comprises of, for example, a news video or audio clip by matching the news video or audio clip with one or more news videos or audio clips in a container of news videos or audio clips.

In particular embodiments, topic analyzer may analyze the topics extracted from received queries in real-time to identify trends, that is, topics that are currently popular or otherwise generating interest among all or a subset of users as determined by, for example, the number of queries submitted around a topic, the number of users querying on the topic, and the frequency of such queries, among other factors such as location of specific queries. A “trending topic” as used herein may be a word, phrase, or topic that is queried a plurality of times and by a plurality of users of the search engine 28. For example, if a number of queries are received regarding the flu, be it queries for remedies, symptoms, etc. by a number of users above a certain threshold, the topic becomes trending. The management system 26 may determine that the frequency of queries may represent an possible outbreak. The network environment 20 may incorporate data from other sources such as GOOGLE®, to better assess the possibility of an outbreak. In one embodiment, trending topics may be stored separately in topic database. In another embodiment, the topic identifiers of topics determined to be trending topics may be flagged or otherwise indicated in topic database. By way of example, for every topic that appears in topics database, topics analyzer computes all of the bursts in the streams of queries containing the topic. Combined with a method for computing a weight associated with each burst, and then for ranking by weight, this essentially provides a way to find the topics that exhibit the most prominent rising and falling pattern (a “trend”) over a limited period of time.

In particular embodiments, the systems and methods disclosed herein are adapted to facilitate the verification and enhancement of data in an online community.

In particular embodiments, the search engine 28 of the network environment 20 delivers both sponsored links and algorithmic search results. The sponsored links may represent hyperlinks to web pages of advertisers who have agreed to pay the search engine operator for listing their hyperlinks on the search results page of users who submit search queries using certain keywords. In a typical arrangement, the advertisers bid on keywords such that higher bids result in higher placement on the search results page. The bids represent the amount the advertisers are willing to pay per click on their online ads. In step 322, the retrieved sponsored concepts are ranked in accordance with the bids submitted by their advertisers, and the retrieved algorithmic search results are ranked based on their relevance as described previously. When the shortlist is updated based upon user preferences in step 338, the sponsored results may be rearranged based on user preferences, for example, click through rate of a particular type of result. This process is illustrated in FIG. 6.

FIG. 6 shows the process for which a third party application requests an authentication code from a user before granting allowing the network environment 20 access their information. At step 410, a request for an authentication code is received. In one exemplary system and method, after a user has logged into a third-party application and a web-based social network, they may be given an option to request the generation of a one-time code that may be either manually or automatically entered into a client device 30 without an Internet browser. At step 420, the authentication code is generated and displayed on the screen of a client device 30. According to further systems and methods, the code may be generated and communicated to the user via other ways, such as but not limited to email or SMS. At step 430, the generated authentication code is received.

In one exemplary system and method, the generated authentication code may be manually or automatically entered in a mobile sensor 70 or client device 30 without an Internet browser (e.g. heart rate monitor or car navigation system) and received via an application program interface to allow the device to authenticate a connection via a third-party application to an Internet website, such as the network environment 20. At step 440, the third-party application is allowed to communicate digital data with the network environment 20. Further, the device may be logged into the third-party application and/or a distributed database environment for an extended period of time. In particular embodiments, this flow process could be the method for user authentication to the network environments 20.

In particular embodiments, after a user has logged into a the network environment and third-party application or a web-based social network, they may be given an option to generate a one-time code that may be either manually or automatically entered into a mobile sensor 70 or client device 30 without an Internet browser. The user may then elect to generate a code that may be entered into a mobile sensor 70 or client device 30 without an Internet browser. The code may be used to keep the mobile sensor 70 or client device 30 without an Internet browser permanently logged into a third-party application. In particular embodiments, a user of a network device who desires to utilize a third-party application such as the web application server 40 for accessing data from the network environment 20 may do so via an API. The user may use the third-party application to access the data after the user has logged into the network environment 20. In an alternate embodiment, when a user accesses a third party web application server 40 from the network environment 20, they may be required to authenticate his or identity in the same way. In one exemplary embodiment, a user of the network environment 20 may login to a web-based social network, such as Facebook®.

Should the user be logging into a third-party application for the first time, the user may be required to accept the terms of service for the use of the third-party application on the social network. For desktop third-party applications, after the user logs into and accepts the terms of service, the user may be directed to close their Internet browser window and to return to the desktop third-party application. Further, the user's ability to have the third-party application access the social network may expire after a fixed period of time. Alternatively, the user may have an option for the third-party application to access the social network for an extended period of time. If the user has previously logged into a particular third-party application and has agreed to the terms of service for the use of the particular third-party application on the social network, the user may not need accept the terms again.

In order to request a session key that does not expire, a third-party application may specify a no timeout parameter in connection with the login procedure. A checkbox may be displayed to the user, wherein if the user checks or highlights the box, the user grants permission for the third-party application to remain connected to the social network for an extended or infinite period of time. Alternatively, in order to request a session key that does not expire, the user may be directed by the third-party application to a specific uniform or universal resource locator (“URL”) where the user may be able to generate a numerical authentication token (or “auth token”). The user may be required to provide the auth token to the third-party application. In both cases, subsequent calls to the web-based social network may return a session key that will not expire. According to a further system and method, the user may be allowed to revoke an extended or infinite session.

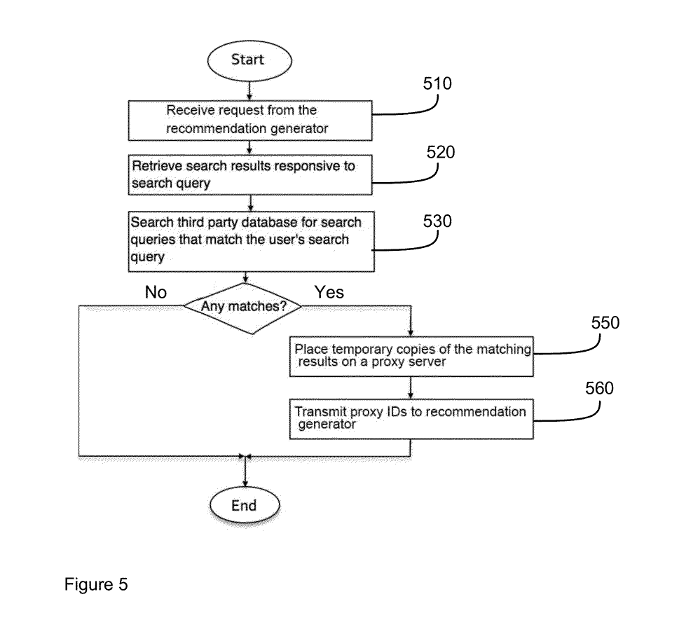

In particular embodiments, the network environment 20 has access to an enterprise server 50 that does not allow for data transactions between environments; such embodiments are more referred to as federated or hybrid network models. FIG. 5, displays an embodiment of a method for accessing a third party database that maintains control of its data. In step 316, the query engine requests access to a third party database. In step 510, the third party database management system receives the request, and in step 520, the database management system retrieves the search results generated by the search engine 28 from one of steps 318 to 320. In step 530, an internal query engine searches the contents of the federated database for containers or contents (depending on the database structure). In step 540, if the process does not discover any matching concepts, then this process ends. If the process does find matches, in step 550, the contents are copied and temporarily placed on an accessible proxy server or communication network 60. In 560, the corresponding proxy concept data IDs are transmitted to the recommendation engine that integrates the proxy IDs with the other concept data sets for relevancy analysis in step 322. In alternate embodiments, the recommendation engine is allowed temporary access to the third party database. In such embodiments the management system 26 may index the third party data base and create query nodes corresponding to the third party database for future queries. Alternatively, the third party database may provide an index to when called at step 510.

In particular embodiments, a query may be submitted by a user from a source or service external to network environment 20, such as, by way of example, via a third-party website, web page, or web application such as, for example, TWITTER® or other blogging service. In particular embodiments, queries made using such third-party services may be automatically imported into and received by the network environment 20. By way of example, a user querying messages or content using a third-party service may indicate that he or she would like to share the query with the network environment 20 via an interactive element presented to the user via the third-party service. The user's query submitted via the third-party service may then appear as a query in, for example, the feed section 920 of the user's homepage. In alternate embodiments, the network environment 20, and particularly servers 22, may include one or more APIs that automatically directly extract queries of users of both the third-party service and network environment 20 from the third-party service such that they are viewable via the user's respective profile or other pages.

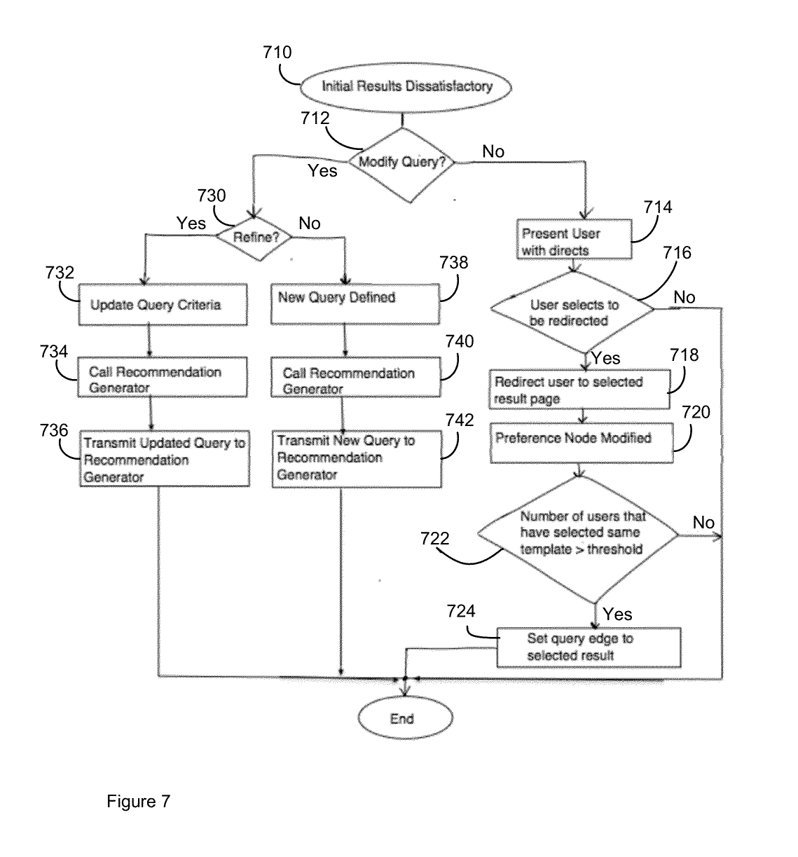

FIG. 6 shows an exemplary user query interface with search query and search results 600, which includes sponsored results 612 and web search results 614, that are generated in response to the sample search query pertaining to a drugs relevance to a user. A user types a search query into the search field 610. In an exemplary embodiment, the search engine is configured to process linguistic syntax and semantics and respond in line through machine intelligence, to further refine the user query and guide the user through the process of using the engine. An example conversation between the user and search engine is shown in 616. The user initially queries the system regarding the efficacy of a drug. Within 614, various links to different types of media and resources are presented. The user is able to “like/dislike” these links by clicking the associated button. In this example, the user finds the initial results, 620, dissatisfactory, which he or she indicated with comment “Not Really.” Alternatively, the user could have used the (lik|dislike) button located next to the engine's comment “How are these results?” These preferences are recorded in the user's search history and used to determine the weight of similar results in future queries. The engine recommends alternative results and possible redirects (not shown) through a process outlined in FIG. 7. In the title of each window are some example options to modify the panel, including, but not limited to: zooming, expanding, minimizing, full screen, closing, moving the panel or editing the contents/preferences associated with its type.

For the purposes of this explanation, the user has opened a redirect in an adjacent window not displayed, and the search engine asks the user if they would like to view the risk factors associated with the drug. If the user chooses to see the risk factors and then the query engine 28 generates a graphic distribution, 630, displaying lines representing media associated with (but not limited to) the drug, evidence of risk factors and de-identified medical histories, to the user in relation to different risk factors and user attributes. The chart features are able to be adjusted and cycled by the user through the use of drop boxes, checkboxes, sliders, facet filtering and navigation, etc. A small map is represents geographic factors that may increase the users risk of (in example) depression. A tab at the top of the interface allows the user to select and open additional visualizations within the same window. Similarly, 620 represents a drug queries by the user. They are presented with a various types of information, represented with different visualizations and further available links to additional material. The query engine is also capable of utilizing alternate input methods in addition to text. The user interface can include a selection box for selecting an attribute for the query, 618. The computer is able to automatically select fields, matching the criteria for such a selection on user preference and user information. The engine 28 may compare user information with that of other, similar members or members that the user shares connections with via the network environment 20 or other social network. Useful publications are presented to user in window 640, sorted by multiple criteria on a two dimensional axis. In this example, the information is sorted by year (x-axis), quality (y-axis), publication type (colour) and relevance to the user/query (size). Those skilled in the art will appreciate that the frameworks provided are for illustrative purposes and far from a complete representation of the concepts presented herein and many other possible embodiments of this invention.

In alternative embodiments, each result may have its own like/dislike button. In particular embodiments, the query engine 28 will populate entire pages with applicable materials immediately upon the user landing on the query engine page. In exemplary embodiments, the engine populates the query results with many applicable resources of multiple media types, including, but not limited to: user health forecasts, methods of improving personal health, geographic and socio-economic factors relating the health and wellness of the user. The user can select treatment options, including the treatment name, for example, “Flourextin” 620. The user interface is not limited to the embodiment described above. Other embodiments of the user interface can include user prompts for entering commands and command options (versus in a lexical manner as described), a voice-activated interface, gestural interface or a touch-screen interface. The user interface can include user interfaces designed to accommodate users requiring greater accessibility.

In particular embodiments, the results may include user disease progression, forecasts and alternate projections depending on treatment and lifestyle choices the user might make. Fox example, a user may be presented with a visualization denoting multiple milestones in relation to cancer progression and type. Different projections may display the effect of chemotherapy on the disease and concurrent the effect on the users health. In this case, milestones can relate to cancer progression (type 1-4), health improvements, recovery levels or any standard scale. Similar to search results, users may become dissatisfied with types of interventions and switch between them, possibly due to side effects. The query result can be displayed as a correlation of the entered medical condition parameters with a medical outcome. As shown in FIG. 6 and FIG. 8, the interface provides a number of visually stimulating and substantial methods for users to glean information about medical conditions and medical outcomes. These visualizations can include a plethora of information relating to a single treatment method or drug, see 620, including but not limited to dosage, alternatives, success rates, etc.

Though not displayed in FIG. 6, the interface is capable of any and all features utilized by popular interfaces. For example, hovering a cursor above an object generates a operation that may present the user with additional information or links; see 936. Type-ahead features, backend autofill features, are other example features.

The method described in FIG. 7 shows the process by which the network environment 20 refines a query when a user indicates a dissatisfactory result. The method begins with (step 710), when a user indicated a search result is dissatisfactory, such as in step 616; the process is touched on in FIG. 2 from the user's perspective. In step 712, the user decides if they would like to modify their previous query or be redirected to another search result. In FIG. 7, this option is presented as a choice before either refinement (step 730) or redirection is allowed (step 714), however in exemplary embodiments, the user is present with the ability to update the query contemporaneous to the ability to select an redirect. In step 714 the user is presented with one or more alternate search results or page redirects to choose from. If the user does not choose to be redirected in step 716, the process either ends or the user has selected to refine their query. If the user does select to be redirected in step 716, the user is redirected to the selected result page (step 718). The user preference node is modified accordingly (step 720). In step 722, the method checks the redirected results popularity. If the number of users that have selected a particular redirect, the attributes of that result are determined to be more preferable to users with similar attributes to the active user and, in step 724 a query edge is set to the selected result.

If the user elects to refine their search, in step 730, they may choose to update the previous query criteria (step 732) by adding additional information or by asking the system a question, as in (step 616). The process of recommendation generator of FIG. 3 is called and the updated query is transmitted to the recommendation generator to be rendered. If in 730 the user instead elects to initiate a new query, in step 738, it is a very similar process, however the previous information is discarded before the process of recommendation generator of FIG. 3 is called and the new query is transmitted to the page generator in step 742. The processes of FIG. 3 and FIG. 3 are tied and cyclical; and therefore a user will be able to simultaneously and cyclically refine his or her query while potentially selecting redirects, allowing the refinement of query results and user preferences, that will be stored in the user nodes for future reference.

More particularly, the user may be prompted with a list of names (e.g., hyperlinks) or thumbnail images of the hubs or profile pages of associated nodes corresponding to the best matches or, alternately, with an “ad” or “social ad” asking the user if he or she would like to be redirected to one of the suggested hubs or profile pages of associated nodes corresponding to the best matches. In particular embodiments, if the user does not click on a redirect link or otherwise select to be redirected to one of the suggested matches, then bootstrapping process (step 214) confirms that the fallback hub node (step 304) is indeed a valid node. In other alternate embodiments, rather then ending the process when the user exits, the method 714 may cause an interface to be presented to the user upon the user's next login that displays redirect candidates that have been matched to alternate or trending concepts.

When a request for a web page or structured document hosted by network environment 20 is received by the network environment 20, one or more page-generating processes of FIG. 3 executing within the network environment 20 typically generate a base web page in the form of a Hyper Text Markup Language (HTML), Extensible Markup Language (XML), or other web browser-supported structured document. The generated structured document is then transmitted in a response, which may comprise one or more portions or partial responses, to the requesting client 30 via a Hypertext Transfer Protocol (HTTP) or other suitable connection for rendering by a web browser (HTTPS) at the client device 30. The structured document may include one or more resources (e.g. JavaScript scripts, code segments, or resources, Cascading Style Sheet (CSS) code segments or resources, image data or resources, video data or resources, etc.), or references to such resources, embedded within the transmitted document.

FIG. 8 shows the process by which the search engine 28 communicates with the knowledgebase 24 and client device 30 to produce results on a user interface. In step 800 (“page generator”) has been called by step 342 of the recommendation generator 300. The template data is received (step 810) from (step 344). This data instructs the page generator of the structure of the result page that will be populated in later steps. In 820, this method transmits the code for generating the structured framework within the web-browser on the client device 30. Next, in step 830, the method requests the content IDs corresponding to the results determined by the process of recommendation generator of FIG. 3. Once the request is received, data is transmitted from step 348 to step 800, where it is received in step 840. Following, step 850 generates code for populating structured document with the selected query results. In step 860 the code is transmitted to the client device 30 and the results are rendered in the user interface. For example, the last user entry in 616 requests the query engine 28 create a whiteboard using the search results. 300 is called much like any other query, however it is given the instruction to create a whiteboard instead of a query result. For this example, let us consider FIG. 9 to be the whiteboard being generated. The corresponding template code is generated 340, and transmitted to 800. The client device 30 receives the instructions to build the base structured document for the whiteboard corresponding to the sections 910, 920, 930, 940, 950, 970, 980 and 990. Subsequently, the structured document is populated with relevant material reflecting the prior query as well as user preferences, information and whiteboard history.

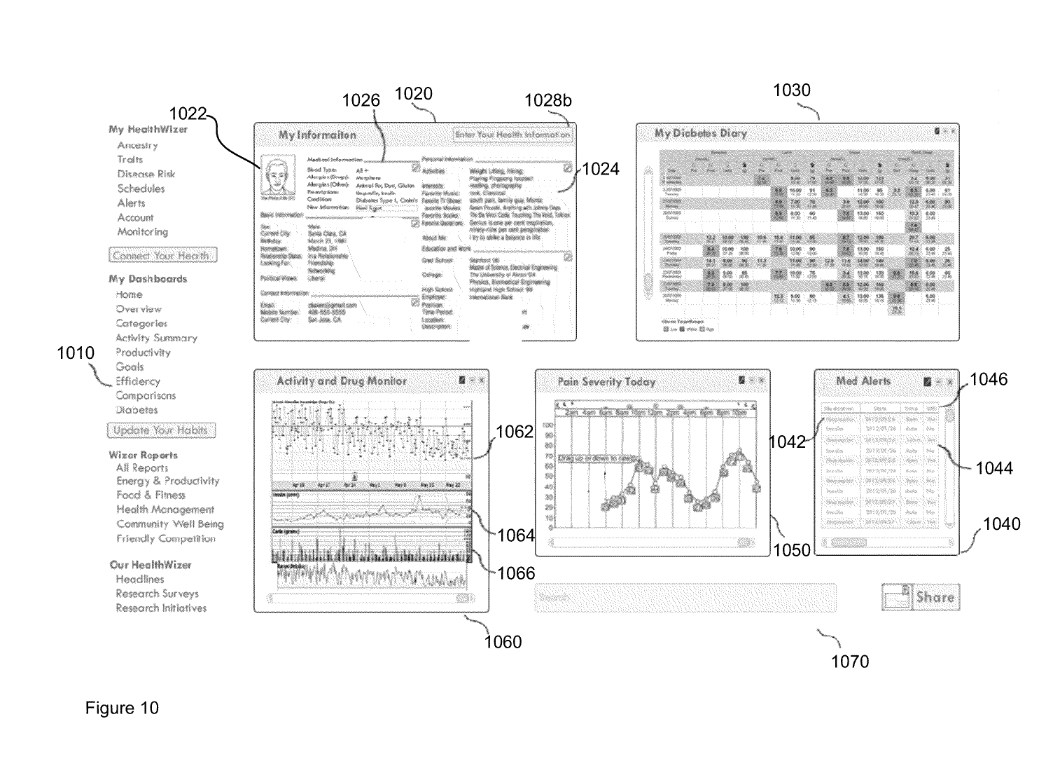

FIG. 9 illustrates an exemplary framework for a user whiteboard, personal dashboard or knowledge hub page (herein referred to as “whiteboard”) 900, with a query engine interface 910, similar to interface 610. The last query entry in 616 requests the query engine 610 to convert the query result page into a whiteboard similar to that of 900. In exemplary embodiments, whiteboard 900 is an augmented whiteboard modified from the original whiteboard requested in step 616. In this regard, whiteboard 900 may represent subsequent query modifications, search refinement in step 730, and personalization following initial generation. This whiteboard may be accessed through the user profile FIG. 10 using a button 1002, query bar 1004 or other forms of page navigation accessible through the user interface on the client device 30.

Panel 920 displays the results of personalized analytics on the user's information. In this example, two trends are displayed in a textual format and to the right are linked to visualizations and/or materials relating to the trend. The “Find Trends” button allows a user to actively investigate their information alongside of machine agents (“agents”) to streamline the process. Additionally or alternatively, the agent creates trends without user assistance. Additionally or alternatively, the user creates trends without agent assistance. For example, user productivity is displayed in 990 alongside user mood 980 and user sleep patterns 970. The agent compares the data trends and uncovers a relationship between the three parameters. The agent presents the user with the results of the analysis and the user may assess the results and enter additional information or data sets to enhance results. For now let us assume the user does not. It is found that when the user has less than 5 hours of sleep, their productivity in the following days decreases in addition to his or her mood. The user realizes that their mood is relative to their productivity and other social events. He or she communicates this to the agent in through a textual interface like 610 or using a checkbox like 618, and indicates that their mood may not be related to sleep. By narrowing the scope of the user information for a given trend allows for trends such as “I need more then 5 hours of sleep” to be generated and sub-whiteboards to be created, populated with internal and external information to evidence this decision, as well as (but not limited to) recommendations, tools and connections. As another example, following the determination of the first trend, the agent continues to investigate possible factors relating to user productivity. For this analysis, the system reviews user nutrition information 1006 to enhance possible trend results. The system uncovers a relationship between breakfast and productivity, particularly the presence of eggs in the users diet. This is how the trend “When I eat eggs, I'm 10% more productive” is generated. The agent may recommend the user test this hypothesis and present one or more procedures for doing so. In an exemplary embodiment, this is a backend process that continues even after the user has gone offline. In particular embodiments, the user may be presented with new trends or surveys to improve trend results upon return to the system. The system is able to utilize machine learning and use habits of other users to automate the discovery of new trends. Assuming the above examples were for user A, the backend agent uses the data relationships (i.e. productivity is related to sleep and nutrition, mood is related to productivity) to assess the trends of user B, who is offline. Similar trends are identified in user B's data, however user B already has a trend relating mood to nutrition. Upon logging back in, user B is presented with the new trends and in relation to his or her information and the pre-existing relationship between mood and nutrition. In the event all three relationships hold, user A may be presented with the possible relationship between mood and nutrition. These examples have been presented comparing two or three data sets, however this is only to exemplify the process and should not limit the volume of data types that can be analyzed at any given time.

Agents also allow for the use of features to contact other members anonymously (herein referred to as a “shout”). Shouts allow users to broadcast a question or a statement to the user community or sub-communities. Agents control the extent to which shouts are transmitted, however agents may deliver a shout to users the “shouter” is unaware of. For example, a user wants to ask a specialist regarding a treatment and medical condition, however they do not have pre-existing connections to such an expert. In particular embodiments, in shouting, the user can specify the criteria for shout targets. An agent uses these criteria to create a shortlist of possible users before transmitting the message, similar to the process of FIG. 3. In particular embodiments, the user is unable to attach a message to the shout. In other embodiments, the user may attach a message. Since an agent is delivering these messages, the recipients' identity is not disclosed until they respond to the shout. In particular embodiments, users can set preferences for what kind of shouts they are interested in receiving. In particular embodiments, the range that these messages can be transmitted is restricted to the network environment 20, however in alternative embodiments, shouts can be sent to third party environments, networks and systems. In particular embodiments, shouts can be transmitted to email addresses directly.

An example news feed is shown in 930. This subsection is populated with different types of documents, such as, but not limited to news articles, publications, videos and maps. In particular embodiments, each concept is presented next to a combination of like/dislike/close buttons, that the user can use to modify the display and modify preferences. In panel 932, information associated with to or pertaining to geography is presented next to a map thumbnail. In particular embodiments, this thumbnail actively displays patterns associated with the user and the concepts next to it. This thumbnail may be a button that can expand into a larger visualization or a hyperlink to a separate whiteboard or webpage. Below in 934, headlines and videos are presented next to preview thumbnails that may either be expanded into larger viewing windows, like the user to an external webpage or separate whiteboard. In 936, information related to a possible treatment is presented. In this example, this section is populated with information about the drug queried in 600. In 936, an example display of hovering information is shown. In general, if a user hovers over some object (i.e. visualization, thumbnail, link, etc.), further details are displayed. In the case of 936, a detailed explanation about the specific treatment is displayed to the user; in 934 the video may be expand to a more suitable viewing size; in 630 a details for what the line represents may be displayed. In 940, a minimized “Virtual Coach” panel is shown. Panel 950 links information, web pages, whiteboards, etc. that user frequents alongside of updates pertaining to the corresponding link.

Within FIG. 9, the user may create panel 960. Alternatively or additionally, 960 may be the layout of the panel when the user elects to edit the panel contents. In this example, the user modifies the panel utilizing a “build bar” and a series of buttons/links below. The build bar is equivalent to the query bar 910 in that it utilizes the query engine 28. It differs, as the user is able to enter the title of the panel to the left of the query interface. In this example, the user has typed “Fitn” and the auto fill (further explained below) feature has filled in the remainder of the word and generated recommendations for possible panel contents below. Within the query interface, the query engine 28 provides an explanatory message that may be overwritten by the user. In alternative embodiments the message may not be present. In particular embodiments, the message may appear after a set time of user inactivity. The “Build” button is synonymous with “create, search or go” and used to generate the panel. Subsection 962 contains buttons corresponding to user data types and information sources available for use in the panel. Examples of such information are nutrition, productivity, workout regiments, blood pressure, etc. In particular embodiments, these buttons are connected to third party information sources hosted from web application servers 30, enterprise servers 50 and/or mobile sensors 70.

Panels 970, 980 and 990 are temporal visualizations of user data, similar to 630. The information displayed within these panels can be managed using drop down menus, sliders and buttons within the panel. Variations are shown between 620, 630, 640, 970, 980 and 990, but these are only to exemplify the invention and are not to be considered all encompassing. As mentioned prior, hovering above an object may provide the user with additional information of one type or another.

In particular embodiments, whiteboards, like FIG. 9, may be or be a component of a hub page (referred to interchangeably as “whiteboard” or “hub page” from here onwards) with an associated topic node similar or a component of an associated concept node. These public whiteboards are may be presented alongside other query results. In particular embodiments, any user created whiteboard can be published as a public or restricted hub page. For example, a user could publish a whiteboard tracking their health progress or about a specific topic of interest to them and restrict access to specific community member or without restrictions. Additionally or alternately, the network environment 20 can provision for possible search queries by populating a hub page automatically as a backend process. Public whiteboards allow users to interact with the user community, encourage each other, share and compare their information, habits and trends. In a particular example, a whiteboard is published as a user homepage or personal health dashboard, FIG. 10. Personal health dashboards are usually only visible to the user for which it was created. A user homepage is typically the landing page other users access first when they enter a user's personal page.

In particular embodiments, public whiteboards connect to other similar whiteboards, potentially sharing feeds and posts, informing users of and facilitating navigation to potentially interesting whiteboards. Alternatively or additionally, users can control what notifications they receive regarding these feeds/posts. In particular embodiments, when a user comments on or otherwise interacts with a related whiteboard they have been presented with in response to a query, the authoring user of the related query may be notified. In particular embodiments, the authoring user may receive “points” when users interact with a whiteboard or information they have published. In particular embodiments, points used as a reward system for encouraging user activity in a social network environment—Reward systems will be discussed in greater detail below. A hub may also generally include a basic information section, a detailed info section, as well as, potentially, other sections, any and all of which may generally be filled in by any authorized user viewing the hub (although in particular embodiments, there may be a time delay associated with a content approval or synchronization process before the user-generated or user-added content is visible in the hub) or, additionally or alternately, auto-populated by the network environment 20. A public whiteboard may include any components and features that would be associated with a hub page on another social network, such as games, videos, pictures, articles. An example may be hub pages located on Facebook®.

In particular embodiments, hubs and their respective hub nodes may be of two varieties such as, for example, whether or not they are considered or classified as generic or non-generic. In one particular implementation, hubs and their respective hub nodes may be “locked” or “un-locked.” Hubs may be locked at the time of creation, or other suitable time, by, for example, the creator or an administrator of the network environment 20. As described above, hubs are essentially community owned, and hence, in particular embodiments, any user of network environment 20 may edit (e.g., add content or declarations to) hubs. However, in particular embodiments, edits in public whiteboards may be published (become visible to the user or other users viewing the whiteboard) immediately while edits in locked hubs may require approval by trusted users or administrators before being modified and presented publicly to users. Additionally, it should be noted that, in some embodiments, the network environment 20 may track the users that added content to hubs as well as when these users added the respective content. In addition to or alternatively, the network environment may award the users that added content with points or other another reward system.

In particular embodiments, the network environment 20 provides means or processes (e.g., selectable links or user interfaces) for experts of the field, such as, but not limited to, clinicians, nutritionists or pharmacists. In particular embodiments, public whiteboards may become locked upon a certified authority figure assuming administrative rights over them and redefining them in the database as, for example, registered authenticated user nodes or, alternately, as authenticated hub nodes.

Typically, the authoring user adds most if not all information presented on a whiteboard, selecting the content they wish to be displayed. Information visibility is controlled by the authoring or administrating user, allowing sections of whiteboards to be made invisible to the general users within a community. For example, in creating a white board, a user may include, proper names (first, middle and last of a person, a trade name or company name of a business entity, etc.) biographic, demographic, medical and other types of descriptive information, in addition to quantitative data regarding the users habits and health, as shown in FIG. 10. The administering user can lock the features a whiteboard to prevent other users from modifying them. For example, locking a visualization window to a specific axis, timeframe and data type.

The online communities described herein can be integrated with one or more reward systems to encourage increased user participation. For example, users may earn credits (also known as points, stars, and the like) for querying information, sending a request for additional information to another user, responding to a request, and the like.

Points or Credits can be used in a variety of ways. The number of points earned by the user can be displayed in the user's profile in addition to or alternate to a graphic badges or medals denoting milestones in, for example the user's fitness level. In particular embodiments, points may be awarded to users that participate in the user community through publishing information, commenting on others posts and answering queries. Additionally or alternatively, users may trade points as a form of online currency within the community. The user can attain various levels reflecting the user's contribution to the online community, either between each other or with agents for services, for example the points could be redeemable for various prizes. Additionally or alternatively, the points can also be used to affect the display of information in the online community. For example, whiteboards created by users may have a point section reflecting the frequency of traffic, likes, etc.

FIG. 10 illustrates an example user profile page of a user corresponding to a user node. In particular embodiments, a user profile page is visible to the user, the user's friends, and even other non-friend users depending on privacy settings, which may be set or modified by the user via the user's profile page or a user homepage, for example 1000. The user profile page may comprise a number of different subpages viewable or accessible via selecting one or more tabs or buttons 1010, including, but not limited to personal health dashboards, whiteboards, photos, analytics, personal information, medical information, educational information, etc. In particular embodiments, profiles include pictures or graphic representations (avatars), 1022, of users that may be displayed to the public based upon privacy settings. Information accessible or visible to the user and other users via the user profile page is self-declared; that is, the user types or otherwise enters information or content in various sections or forms that may or may not automatically appear by default when the user profile page is created. In particular embodiments, a user may edit his or her user profile page at anytime the user is logged into network environment 20.

In particular embodiments, a user profile page may also include a personal information section 1020 where the user can enter more personal declarations. By way of example, user profiles include data that describe the respective users of the social network, which may include, for example, biographic, demographic, and other types of descriptive information in a basic information section. By way of example, a personal information section 1020 may include a sub-section 1024 in which the user may various information about activities they do and information about their lives. For example, the user may list “weight lifting” or may use phrases such as, for example, “I enjoy weightlifting.” In particular embodiments, the health information section 1026 includes a health metric field 1028, where a user is able to input a health metric (in this example, the heel spurs). There is no limit to the number of metrics a user can input. Users can enter any metric and the auto fill process will attempt to fill the entry. In the case of a new node, the system follows a process similar to as described in the background material. In particular embodiments, health metrics may be collected by and accessed through a third party web environment 40, for example, DIGIFIT® collects and transmits heart rate and fitness data onto a web application server and makes this data available through an API. This type of information can be added into users personal information autonomously, as described previously in the health feeds section, 962. In exemplary embodiments, users are able to carefully monitor their health information in charts. For example, a user is able to upload their data collected by a continuous glucose monitor into their profile and display it as a chart 1030.

In particular embodiments, the user can set up tracking and reminder features, 1040, such as, but not limited to reminders, surveys, messages and emails, to prompt user entry of data relating to specific metrics. Various types of remedies can be scheduled for specific times. For example, 1042, the user can be prescribed to take ibuprofen at 8 A.M., 12 P.M. and 4 P.M., 1044. In this situation, user interface can display a medication schedule and send the user reminders about their medication. The user can modify this schedule to accurately gauge what was administered by dragging marker. The user can confirm the consumption of the drug on the user interface or by other means, such as SMS, 1046. Once confirmed, the appearance of the marker/chart can change, helping people maintain their prescriptions. In particular embodiments, all personal information (including but not limited to health information) can be plotted temporally and analyzed by agents to discovery trends and relationships within the user node. In particular embodiments, users are able to enter information into a visual interface 1052 using modular features to adjust time, date, severity, etc. For example, a user may enter their mood or pain levels into a table 1050 over the span of a day using a series of buttons and dials as shown. In exemplary embodiments, 1060 displays various activity data, including blood glucose 1062, pharmacokinetic data 1064 that depicts the concentration of a insulin within the user over time. In exemplary embodiments, activity data can be overlaid with other measurements such as meals and active feeds from sensors 1066.

Health information can further include a plurality of condition parameters, such as a disease symptom, a treatment, a treatment reason, a treatment side-effect, a treatment dosage, a diagnosis, a stage of disease, nutritional information, environmental information, activity information, geographic information, genotypic data, phenotypic data, family history data, or a milestone related to the medical condition. The condition parameters are associated with a particular disease or conditions (for example, Amyotrophic Lateral Sclerosis, Multiple Sclerosis, Parkinson's Disease, etc.) or combination of diseases or conditions. Users can also enter data on various events (e.g., changes in medical condition). For example, a user taking Accutane for severe acne may report that he has developed light sensitivity, sore joints and insomnia. Drug response data can be aggregated across multiple users and used to identify adverse effects, providing useful information for the identification of previously unknown adverse drug-drug interactions. In particular embodiments of this invention, user health information includes DNA sequencing. In such cases, the use of bioinformatics can allow the discovery of drug efficacy based on personal genetics and other trait information. User health information can even further be expanded to include outcome parameters such as survival, disease symptoms, a treatment, a treatment reason, a treatment side-effect, a treatment dosage, a diagnosis, a stage of disease, nutritional information, environmental information, activity information, geographic information, genotypic data, phenotypic data, family history data, a milestone related to the medical condition, a medical prediction, or an aggregation of medical condition parameters.

Public and Private whiteboard, including profile and homepages may still include one or more visualizations 640, 990 depicting predictions of the progression of the user's health. In some embodiments health, disease and recovery values can be generated presenting the user with one or more of (i) recovering from a disease, (ii) living with a disease, or (iii) dying over a twenty-five year period, variations subject to user fitness activity, diet and habits (such as smoking). Through the use of multi-agent techniques, the system is able to create predictive models, allowing users to deduce the possible outcomes of choices they make regarding their health and wellness, while understanding the possible risk factors and complications that may occur along the way. In particular embodiments, prediction reliability may be represented by a graphical or textual element near or attached to predictions. Additionally, the system can simulate the effect of earlier actions that were either taken or not taken. For example, a user can display the predicted disease progression for colon cancer if the cancer was detected two years earlier. Additionally, the system may run complete simulations based on data sets to educate users about their health. The user can plan a treatment method based on the query result 620, and the forecasting methods discussed previously. Alternatively, the user's doctor, nurse, or medical assistant may recommend the plan to the user.

The system enables users to access and participate in clinical trials over a virtual format, conduct health experiments, such as different diets and participate in widespread online community health competitions. A clinical trial can be initiated by one or more users, a researcher, an administrator, or other person or organization. The clinical trial can test the efficacy of any intervention such a medication. If the intervention is a prescription medication, users in the community may need to obtain the medical from their doctor, e.g., through an off-label prescription. Other interventions can be tested without the legal requirement of a physician.

In particular embodiments, one or more terms in declarations entered in one or more of the previously described sections or sub-sections may be highlighted, rendered in a different color, underlined, or clickable. By way of example, one or more terms entered as declarations, and particularly terms matched to known concepts or existing concept nodes, may be associated with a hyperlink that, when clicked or otherwise selected, directs the user to a concept profile page devoted to the term and, in particular embodiments, having a name identical or similar to the declared term. By way of example, clicking on a hyperlink corresponding to “Diabetes” may direct the user to a whiteboard or search result devoted to Diabetes, 1070.

It will be apparent from this description that aspects of the present invention may be embodied, at least in part, in software. That is, the techniques may be carried out in a computer system or other data processing system in response to its processor, such as a microprocessor, executing sequences of instructions contained in memory. In various embodiments, hardwired circuitry may be used in combination with software instructions to implement the present invention. Thus, the techniques are not limited to any specific combination of hardware circuitry and software nor to any particular source for the instructions executed by the data processing system.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

The embodiments of the invention in which an exclusive property or privilege is claimed are defined as follows:

1. A computer-implemented method for heterogeneous data management and/or for managing data relevance and generating data/metadata relevance representation, the method comprising the steps of:
obtaining, via a network environment, information from a at least one data source;
modeling, by a data/metadata modeling unit, the data/metadata from each of the data sources based on at least one feature and/or granularity information and/or data/metadata model(s) associated with the data/metadata to generate data/metadata models;
integrating, by a data/metadata integration unit, the data/metadata from at least one data source, by applying at least one process to the data/metadata from different data sources in accordance with the data/metadata models, to generate integrated data/metadata;
creating, by a relevance representation generator, a relevance representation of the integrated data/metadata that traces sources, granularities, and/or processes applied to generate the integrated data/metadata;
receiving, by a data/metadata manager, a query originated from a user, regarding information associated with the integrated data/metadata;
providing, by the data/metadata manager, a response directed to the query derived based on the relevance representation of the integrated data/metadata;
generating, by a page generator, instructions corresponding to the creation of a dashboard/visualization/interface to display a query result based on the relevance representation of the integrated data/metadata;
updating, by a data/metadata manager, a response directed to the relevance representation generator and/or page generator, based on a query, data/metadata and model relevance and/or granularity, model and/or instructions and/or response that may have originated from a user and/or a model and/or a data/metadata manager; and
archiving the relevance representation of the integrated data/metadata for enabling an query associated with the integrated data/metadata on source and/or granularity.

2. The method of claim 1, wherein the step of modeling comprises:
extracting data/metadata from at least one underlying source;
extracting identifying information used to identify the underlying source;
determining a granularity of the data/metadata from the underlying source;
generating at least one model for the data/metadata from the underlying source based on the identifying information and the granularity of the data/metadata, wherein at least a portion of said models are generated with machine learning, machine intelligence, human intelligence, synthetic intelligence, statistical, analytic and algorithmic models via one or more of the data/metadata types, models or processes; and
outputting at least one model generated for the data/metadata from the underlying source, wherein at least a portion of said models generate statistical, analytic and algorithmic models via one or more of the data/metadata types, models or processes; a plurality of forecasts, recommendations and/or projections; outcome from at least one forecasts and/or recommendations and/or projections.

3. The method of claim 1, wherein the step of integrating comprises:
receiving data/metadata models for data/metadata from the plurality of data sources;
determining a sequence of the one or more processes applied to integrate the data/metadata based on the data/metadata models, wherein at least a portion of said models are selected with machine learning, machine intelligence, human intelligence, synthetic intelligence, statistical, analytic and algorithmic models via one or more of the data/metadata types, models or processes;
invoking, in accordance with the sequence, the one or more processes to process the data/metadata from the plurality of sources to generate the integrated data/metadata; and
recording the sequence of the one or more processes applied.

4. The method of claim 1, wherein the step of providing comprises:
analyzing the query received;
retrieving information relating to the source, granularity of the integrated data/metadata, process applied on the data/metadata from the relevance representation or inferring a relationship inquired by the query based on the information retrieved; and
generating the response to the query based on the information retrieved from the relevance representation and/or the relationship inferred.

5. The method of claim 1, wherein the step of creating comprises:
in response to receiving a query or request pertaining to a plurality of determinants deploying portals utilizing a data, statistical or algorithmic model to predict a plurality of scientific, medical, social or economic processes, outcomes or methods, such as, but not limited to market access, economic valuation or scientific valuation; and
assessment of at least one model generated for each model of each outcome to select an optimal outcome and/or template to be presented;
assessment of a plurality of competing models generated for each model of each outcome to select an optimal outcome and/or template to be presented; and
selection of at least one model generated for each model and/or data/metadata.

6. The method of claim 1, wherein the step of receiving comprises:
the analysis of the query received by the data/metadata manager;
retrieval of information relating to at least one of the user, the source, granularity of the integrated data/metadata, process applied on the data/metadata from the relevance representation or infer a relationship inquired by the query based on the information retrieved; and
generation of a response to the query based on the information retrieved from the relevance representation and/or the relationship inferred.

7. The method of claim 1, wherein data/metadata is categorized based on at least one ontology, comprising:
a categorizer unit, comprising of a data/metadata manager/processor, further comprised of at least one ontology, each ontology comprising of at least one hierarchical taxonomy and each hierarchical taxonomy comprising of at least one taxon; wherein the data/metadata manager/processor receive data/metadata to be classified and submit the data/metadata to the categorizer unit;
further wherein the categorizer analyses the data/metadata by at least one semantic, grammatical and/or ontological granularity before categorizing the data/metadata with at least one ontological rule, weight and/or category; and
storing a resulting data/metadata categorization within at least one index, comprising of at least one data/metadata and/or categorization, and further comprising of at least one ontology, each ontology comprising of at least one hierarchical taxonomy and each hierarchical taxonomy comprising of at least one taxon.

8. A method of claim 1 comprising the further steps of:
receiving an unstructured search query;
parsing the unstructured search query into at least one structured search attribute using a search term attribute dictionary, natural language processor, ontology or model;
performing a search of a structured database based upon at least one of a structured search attribute, natural language processor, ontology or model, to identify at least one search result;
populating a plurality of form fields of a search form with at least one of: structured search attribute, natural language processor, ontology or model; and
displaying the search form in association with the search results.

9. A system for heterogeneous data management and/or for managing data relevance and generating data/metadata relevance representation, the system comprising:
a heterogeneous data/metadata input unit configured for obtaining, via a network environment, information from a plurality of data sources;
a data/metadata modeling unit configured for modeling the data/metadata from each of the data sources based on a source and/or granularity information associated with the data/metadata to generate at least one data/metadata model;
a data/metadata integration unit configured for integrating the data/metadata from at least one data source, by applying at least one process to the data/metadata from different data sources in accordance with at least one data/metadata model, to generate integrated data/metadata;
a relevance representation generator configured for creating a relevance representation of the integrated data/metadata that traces sources, granularities, user preferences, user histories and/or processes applied to generate the integrated data/metadata;
a data/metadata manager configured for receiving a query, originated from a user, regarding information associated with the integrated data/metadata and providing a response directed to the query based on the relevance representation of the integrated data/metadata.

10. The system of claim 9, wherein the data/metadata modeling unit comprises:
a data/metadata relevance extractor configured for extracting identifying information used to identify the underlying source
a data/metadata granularity extractor configured for determining a granularity of the data/metadata from the underlying source;
a relevance model generator configured for generating a model for the data/metadata from the underlying source based on the identifying information and the granularity of the data/metadata and outputting the model generated for the data/metadata from the underlying source.

11. The system of claim 9, wherein the data/metadata integration unit comprises:
a data/metadata processing controller configured for receiving data/metadata models for data/metadata from the plurality of data sources, determining a sequence of one or more processes to be applied to the data/metadata from different data sources, and invoking the one or more processes to process corresponding data/metadata accordingly to generate the integrated data/metadata; and
a process logger configured for recording the sequence of one or more processes applied to the data/metadata and outputting the recorded sequence applied to the data/metadata from the data sources.

12. A method for providing automatic decision support with heterogeneous data/metadata, data/metadata models and/or machine intelligence(s), comprising of:
in response to receiving a query or request pertaining to a plurality of determinants deploying portals utilizing a data, statistical or algorithmic model to predict a plurality of scientific, medical, social or economic processes, outcomes or methods, such as, but not limited to market access, economic valuation or scientific valuation;
assessment of at least one model generated for each model of each outcome to select an optimal outcome and/or template to be presented;
assessment of a plurality of competing models generated for each model of each outcome to select an optimal outcome and/or template to be presented; and
selection of at least one model generated for each model and/or data/metadata.

13. The method of claim 12, further comprising of at least one of:
retaining the input of personalized data and query parameters for searching an indexed and potentially distributed and/or federated database, and producing a query result particular to the person;
viewing and analyzing personal metrics and attributes to better understand and manage one's health, and wellness;
aggregation, retrieval and ad hoc visualization of a plethora of information of multiple data types and specificity.

14. The method of claim 12, wherein information pages are generated with information and/or models aggregated from at least one source, that may further comprise of at least one of:
the analysis of information, presenting patterns, trends and habits, providing the user insight into their own health and wellness;
presenting users with materials to empower users with the knowledge to better understand and manage their health and wellness;
presenting users with a means to manage and forecast their health based on quantitative data augmented by machine intelligences;

15. A method for heterogeneous data management by cooperative systems where machine intelligent agents interact with a user via an interface to enhance system functionality and user experience, quality and efficiency of design, wherein:
in response to receiving a query or request pertaining to at least one query, determinant, data/metadata, model and/or outcome, deploying portals utilizing at least one data/metadata model;
assessment of at least one model generated for each model of each outcome to select an optimal outcome and/or template to be presented;
users' behavior models are generated to incentivize user engagement and/or activity by rewarding users for at least one of communicating with other users, competing with other users, participating in multi-user activities, and
wherein users' behavior models are used to enhance cooperation and collaboration within a social network environment.

16. The method of claim 15, wherein an interactive and intelligent user interface facilitates the collection, assessment and provisioning of heterogeneous data, comprising of at least one of these steps:
accepting user inputs, for example, but not limited to search queries;
generating a query result including one or more matching concepts stored in a knowledgebase of one or more media types;
determining the relevancy of resources, including but not limited to multimedia particular to each user;
presenting the user with a rich personalized query result based on the user's preferences and personal information.

17. The method of claim 15, wherein data/metadata is categorized based on at least one ontology, comprising:
a categorizer unit, comprising of a data/metadata manager/processor, further comprised of at least one ontology, each ontology comprising of at least one hierarchical taxonomy and each hierarchical taxonomy comprising of at least one taxon;
wherein the data/metadata manager/processor receive data/metadata to be classified and submit the data/metadata to the categorizer unit;
further wherein the categorizer analyses the data/metadata by at least one semantic, grammatical and/or ontological granularity before categorizing the data/metadata with at least one ontological rule, weight and/or category; and
storing a resulting data/metadata categorization within at least one index, comprising of at least one data/metadata and/or categorization, and further comprising of at least one ontology, each ontology comprising of at least one hierarchical taxonomy and each hierarchical taxonomy comprising of at least one taxon.

18. The method of claim 15, further comprising:
receiving an unstructured search query;
parsing the unstructured search query into at least one structured search attribute using a search term attribute dictionary, natural language processor, ontology or model; performing a search of a structured database based upon at least one of: a structured search attribute, natural language processor, ontology or model, to identify at least one search result;
populating a plurality of form fields of a search form with at least one of: structured search attribute, natural language processor, ontology or model; and displaying the search form in association with the search results.

19. The method of claim 15, comprising:
a heterogeneous data/metadata input unit configured for obtaining, via a network environment, information from a plurality of data sources;
a data/metadata modeling unit configured for modeling the data/metadata from each of the data sources based on a source and/or granularity information associated with the data/metadata to generate at least one data/metadata model;
a data/metadata integration unit configured for integrating the data/metadata from at least one data source, by applying at least one process to the data/metadata from different data sources in accordance with at least one data/metadata model, to generate integrated data/metadata;
a relevance representation generator configured for creating a relevance representation of the integrated data/metadata that traces sources, granularities, user preferences, user histories and/or processes applied to generate the integrated data/metadata;
a data/metadata manager configured for receiving a query, originated from a user, regarding information associated with the integrated data/metadata and providing a response directed to the query based on the relevance representation of the integrated data/metadata.

20. The method of claim 19, wherein the data/metadata modeling unit comprises:
a data/metadata relevance extractor configured for extracting identifying information used to identify the underlying source
a data/metadata granularity extractor configured for determining a granularity of the data/metadata from the underlying source;
a relevance model generator configured for generating a model for the data/metadata from the underlying source based on the identifying information and the granularity of the data/metadata and outputting the model generated for the data/metadata from the underlying source.

21. The method of claim 19, wherein the data/metadata integration unit comprises:
a data/metadata processing controller configured for receiving data/metadata models for data/metadata from the plurality of data sources, determining a sequence of one or more processes to be applied to the data/metadata from different data sources, and invoking the one or more processes to process corresponding data/metadata accordingly to generate the integrated data/metadata; and
a process logger configured for recording the sequence of one or more processes applied to the data/metadata and outputting the recorded sequence applied to the data/metadata from the data sources.
